(19) United States
(12) Patent Application Publication
(10) Pub. No.: US 2016/0144747 A1
(43) Pub. Date: May 26, 2016

(54) DEVICE FOR ADJUSTING THE SEAT INCLINATION OF A MOTOR VEHICLE SEAT

(71) Applicant: JOHNSON CONTROLS COMPONENTS GMBH & CO KG, Kaiserslautern (DE)

(72) Inventors: Viktor ENNS, Kaiserslautern (DE); Thomas DILL, Heiligenmoschel (DE); Jakob WIEGE, Kaiserslautern (DE)

(21) Appl. No.: 14/900,208

(22) PCT Filed: Jun. 18, 2014
(86) PCT No.: PCT/EP2014/062824

§ 371 Date: Dec. 21, 2015

(30) Foreign Application Priority Data
Jun. 19, 2013 (DE) 10 2013 106 410.8

(51) Int. Cl. B60N 2/10; B60N 2/68

(52) U.S. Cl. CPC B60N 2/10; B60N 2/68; B60N 2/686

(57) ABSTRACT

A device for adjusting the seat inclination of a motor vehicle seat, includes a seat frame and a seat shell, which are connected to each other in an articulated manner by two fastening elements. The fastening elements each extend through a respective accommodating opening on the seat frame and a respective bearing opening on the seat shell. In order to provide a device for adjusting the seat inclination for a motor vehicle seat that can be produced simply and installed fully automatically, has a lower total weight, and has especially high stability, the material of the seat shell has a greater material thickness in the region of the bearing openings than in the other regions of the seat shell.

### CROSS REFERENCE TO RELATED APPLICATIONS

This application is a United States National Phase Application of International Application PCT/EP2014/062824 filed Jun. 18, 2014 and claims the benefit of priority under 35 U.S.C. §119 of German Patent Application 10 2013 106 410.8 filed Jun. 19, 2013 the entire contents of which are incorporated herein by reference.

### FIELD OF THE INVENTION

The invention relates to a device for adjusting the seat inclination of a motor vehicle seat, comprising a seat frame and a seat shell which are connected to each other in an articulated manner by means of two fastening elements which each extend through a respective receiver opening on the seat frame and a respective bearing opening on the seat shell.

### BACKGROUND OF THE INVENTION

Devices for adjusting the seat inclination of a motor vehicle seat of the type mentioned in the introduction are known in many different embodiments from the prior art and are used in motor vehicle seats and utility vehicle seats to adjust the inclination of a part of a seat surface, in particular a portion of the seat surface facing the seat front face, or even to adjust the entire seat surface.

In the devices known from the prior art for adjusting the seat inclination, the seat shell is shaped for increasing the stability in the regions of the bearing opening such that said seat shell surrounds the seat frame on both sides, both on the seat outer face and on the seat inner face, wherein for the articulated connection of the seat frame and the seat shell a threaded bolt is fully guided through both sides of the seat shell and through the seat frame and is secured by means of a nut.

However, such an embodiment results in numerous drawbacks. Initially, the production of a seat shell shaped in such a complex manner is costly and, moreover, such a seat shell has a considerable weight which counteracts the aim of minimizing weight which is desired, in particular, in the automobile industry. Additionally, the mounting of the threaded bolt with the nut is complex and is only able to be carried out in an automated manner with difficulty.

Finally, the embodiment of the prior art has the drawback that the region of the two bearing openings has to be additionally reinforced on each side of the seat shell by arranging one respective bush and by shaping the material, so that the seat shells withstand the forces which act through the threaded bolts and/or the nuts on the surfaces during pivoting and the material does not shear off in the region of the bearing openings.

### SUMMARY OF THE INVENTION

An object of the invention, therefore, is to provide a device for adjusting the seat inclination of a motor vehicle seat which is able to be produced in a simple manner and which is able to be mounted fully automatically, which has a lower overall weight and at the same time has a particularly high degree of stability.

The object is achieved according to the invention by a device for adjusting the seat inclination of a motor vehicle seat, which device comprises a seat frame and a seat shell which are connected to each other in an articulated manner by means of two fastening elements which each extend through a respective receiver opening on the seat frame and a respective bearing opening on the seat shell, wherein the material of the seat shell has a greater material thickness in the region of the bearing openings relative to the remaining regions of the seat shell.

In this case, the greater material thickness of the seat shell in the region of the bearing openings advantageously permits the seat shell on each side of the vehicle seat to be designed to be mounted on the seat frame only on one side, in particular of the seat outer face. As a result, not only the overall weight of the device for adjusting the seat inclination is advantageously reduced relative to the known devices but also the production of the device is simplified. The mounting of the seat shell on the seat frame by means of the fastening element may take place in a particularly simple manner, optionally even fully automatically. In addition, the greater material thickness increases the rigidity and stability of the seat shell in the region of the bearing openings, whereby the maximum load-bearing capacity of the device for adjusting the seat inclination may be significantly increased without great effort.

In principle, the device for adjusting the seat inclination may be formed from any number of further components, it may consist of any material and may fulfill further functions beyond the function of adjusting the seat inclination.

In this case, “device for adjusting the seat inclination” is initially understood as any technical device which is provided on a motor vehicle seat in order to adjust the inclination of a part of the seat surface or the entire seat surface of the vehicle seat relative to a seat frame, in particular to pivot about an axis.

In this case, “motor vehicle seat” is understood as any vehicle seat which is generally installed in a motor vehicle. In particular, the motor vehicle seat is a seat for an individual occupant of a motor vehicle, wherein, for example, it may be a passenger motor vehicle, a heavy goods vehicle or a different utility vehicle.

The seat frame may, in principle, be formed from any material, for example a metal, a plastics material or a composite material. In this case, the seat frame has the function of forming the basic structure of the vehicle seat, wherein the seat shell and/or a backrest and/or further components are arranged on the seat frame. Moreover, it is a function of the seat frame to arrange the vehicle seat fixedly on the motor vehicle, if required via further components.

Preferably, the seat frame is at least two profile elements extending substantially parallel to one another on each of the two sides of the vehicle seat, said profile elements being able to be connected together via a further profile element on the seat front face or the seat rear face and being able to be formed integrally with one another.

The seat shell may be a component which is arranged at least partially on the seat frame and which has the function of supporting a passenger positioned on the vehicle seat, wherein any upholstery elements may be arranged between the passenger and seat shell. In addition, the purpose of the seat shell is to provide the detailed shaping of the seat surface, whereas it is the purpose of the seat frame to produce the required stability and load-bearing support of the vehicle seat.

The bearing opening and/or the receiver opening may, in principle, be an opening of any shape to receive a fastening element, wherein the bearing opening and/or the receiver opening preferably have a circular shape. In this case, the diameter of the opening particularly preferably corresponds to the diameter of a fastening element to be arranged therein. Both the seat frame and the seat shell in each case have two corresponding openings, wherein both the receiver openings on the seat frame and the bearing openings on the seat shell are arranged opposite one another on the respective components so that in each case both openings of one component have a common central longitudinal axis, whereby the seat shell is able to pivot relative to the seat frame about this central longitudinal axis without distortion.

Further preferably, the receiver opening is arranged centrally in a side surface of the seat frame, such that the central longitudinal axis of the circular receiver opening, and thus also the adjustment axis of the seat shell, extend about a fastening element arranged in the receiver opening, approximately parallel to the seat surface and at right angles in the direction of the seat front face.

The fastening element may initially be any means for fastening, in particular arranging, the seat shell on the seat frame in an articulated manner, quite particularly in a rotationally articulated manner, namely a bolt, a screw, a pin, an axle, a shaft or any other structural element. Preferably, the fastening element is a component which has a circular cross section at least in a region by which it is arranged in the receiver opening of the seat frame and/or in the bearing opening on the seat shell.

In this case, the fastening element is preferably formed from a material which is resistant to deformation and wear, namely a plastics material or a metal, in particular a steel.

Preferably, the majority of the seat shell has a uniform material thickness, whereas according to the invention the material of the seat shell in the region of the bearing openings, preferably surrounding the bearing opening at least on all sides, has a greater material thickness relative to the remaining regions of the seat shell.

According to an advantageous development of the invention, the seat shell in the region of the bearing openings has a material thickness which is at least twice as high relative to the remaining regions of the seat shell, whereby the seat shell in the region of the pivotable arrangement on the seat frame is designed in a simple manner to be particularly stable relative to deformation, distortion or the occurrence of a defect and, due to the simple shape permitted thereby, only has a low overall weight.

According to a preferred embodiment of the invention, the seat shell in the region of the bearing opening has a greater material thickness, preferably twice the material thickness, as a result of a folded-over portion of an edge region, whereby a selective material reinforcement of a component, which has a uniform material thickness substantially in all regions, may be achieved in a particularly simple manner. Moreover, by the folding-over process, the edge region of the seat shell is advantageously prevented from having sharp edges and at the same time a particularly high dimensional stability is achieved.

Alternatively a greater material thickness, preferably twice the material thickness, of the seat shell may be achieved in the region of the bearing opening by the corresponding shaping of a region inside and/or below the seat shell. In particular, it is conceivable to shape the material of the seat shell forming the region of the bearing opening such that it results in a duplication of material. This may take place both by shaping one edge, in particular a lower edge of the seat shell facing a vehicle floor, and by folding back material which forms an upper edge facing the seat surface for receiving a passenger and/or a side region of the seat shell. Moreover, material of further parts of the seat shell, in particular integrally formed support ribs, reinforcing profiles or fastening devices, may be used in order to achieve a material reinforcement, preferably a duplication of material, in the region of the bearing opening.

According to an advantageous embodiment of the invention, the fastening element is formed by a bolt with a threaded pin, wherein an outer thread of the threaded pin cooperates with an inner thread formed on the receiver opening of the seat frame, whereby the fastening of the bolt to the seat frame takes place in a particularly simple manner and as a result fully automated mounting is permitted.

According to a further advantageous embodiment of the invention, the fastening element at one end has a head, in particular a cylindrical head and/or a receiver for a tool. The design of one end of the fastening element as a cylindrical head permits the fastening element to be supported in a simple manner against a surface of the seat shell, whereby forces acting between the components along a central longitudinal axis of the fastening element may be distributed particularly uniformly onto the seat shell in a simple manner. A receiver, in particular a receiver opening, for a tool on the fastening element, in particular on the head of the fastening element, permits a particularly simple and rapid mounting of the device.

According to a preferred development of the invention, the fastening element has a thread-free surface in a bolt region of the fastening element, said bolt region being provided for arranging in the bearing opening of the seat shell and being particularly preferably cylindrical, and the length of said thread-free surface quite particularly preferably corresponding to the depth of the bearing opening, whereby firstly a slidable mounting of the seat shell on the fastening element is ensured in a particularly simple manner. Secondly, an adaptation of the length of a thread-free surface to the depth of the bearing opening of the seat shell permits an arrangement without clearance of the seat shell on the seat frame in a simple manner.

According to a further preferred embodiment of the invention, the cylindrical bolt region of the fastening element has a greater diameter than the threaded pin forming the end region of the fastening element, whereby an end surface of the bolt region which extends radially to the central longitudinal axis of the fastening element, the surface of the seat frame which surrounds the receiver opening bearing thereagainst, in this case both secures the fastening element against deformation relative to the seat frame and permits an arrangement without clearance of the seat shell on the seat frame in a simple manner.

According to an advantageous development of the invention, a bearing bush is arranged on the bearing opening of the seat shell, whereby a further reinforcement of the edge regions of the bearing opening is achieved in a particularly simple manner and wear of the device due to operation may be reduced.

According to a further advantageous development of the invention, the bearing bush secures two material layers of the seat shell positively and/or non-positively against one another, said material layers bearing against one another by means of a folded-over portion. In this case, the outer diameter of the bearing bush may correspond to the inner diameter of the bearing opening and/or the parts of the bearing bush protruding from the bearing opening may be compressed such that a contact force on the material layers of the seat shell located on top of one another is exerted in the region of the bearing opening, whereby a further stabilization of the device for adjusting the seat inclination is achieved in a particularly simple manner.

According to a preferred embodiment of the invention, the seat shell is formed in one piece, particularly preferably from a metal sheet, wherein quite particularly preferably the metal sheet has a uniform material thickness for producing the seat shell.

Further preferably, the seat shell has two side portions extending substantially parallel to the two lateral regions of the seat frame and a front portion which is aligned with the seat front face and which connects together the two side portions of the seat shell, whereby the seat shell determines both the shape of the seat front edge and also ensures a lateral stabilization of a passenger on the vehicle seat.

According to an advantageous development of the invention, the seat shell extends, in particular the side portions of the seat shell extend, over part of the length of the seat frame, wherein the seat shell preferably has approximately half the length of the seat frame, whereby a part of the seat surface of the vehicle seat is able to pivot in a particularly simple manner and thus the shape of the seat surface itself is able to be adjusted.

According to a preferred embodiment of the invention, the bearing openings of the seat shell are respectively arranged in an end region of the side portions opposing the front portion, whereby the seat shell, which is arranged so as to bear partially against the seat frame, is able to pivot in a simple manner by means of a pivot axis in the region of the center of the seat surface.

An exemplary embodiment of the invention is described in more detail hereinafter with reference to the drawings

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of an embodiment of a device according to the invention for adjusting the seat inclination of a motor vehicle seat;

FIG. 2 is a perspective view of a section through the central longitudinal axis of a fastening element of the embodiment shown in FIG. 1 of the device for adjusting the seat inclination;

FIG. 3 is a perspective view of a seat shell of the embodiment of the device shown in FIG. 1 for adjusting the seat inclination;

FIG. 4 is a perspective view of a detail of the seat shell shown in FIG. 3 in the region of a bearing opening; and

FIG. 5 is a perspective sectional view of the detail shown in FIG. 4 of a seat shell in the region of the bearing opening.

### DESCRIPTION OF THE PREFERRED EMBODIMENTS

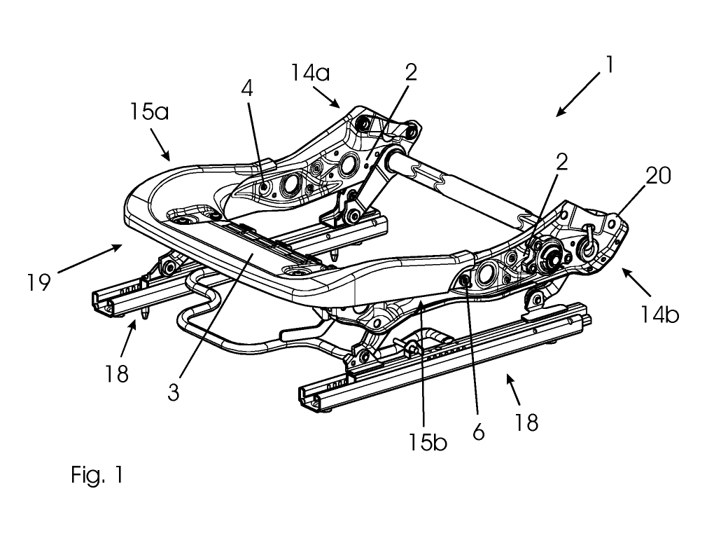

In the embodiment shown in FIG. 1 of a device for adjusting the seat inclination 1 of a motor vehicle seat, a seat shell 3 is arranged in an articulated manner on a seat frame 2.

The seat frame 2 in this case is formed from two profile components arranged parallel to one another, in each case above a seat rail pair 18. A circular receiver opening 4 is provided with an inner thread 12 centrally in the surface of each of the two profile components, both relative to the direction of the seat height and in the direction of the seat length between the seat front edge 19 and the rear face of the seat, the backrest 20 being adjacent thereto, wherein the two receiver openings 4 of the device for adjusting the seat inclination 1 are arranged exactly opposite one another on the motor vehicle seat.

A bolt 9 with a threaded pin 10 is provided in each of the two receiver openings 4 on the seat frame 2 for the articulated arrangement of the seat shell 3, wherein the seat shell 3 in the region of the receiver openings 4 in each case is located on the surface of the seat frame 2 facing the seat outer face. In this case, the bolt 9 is formed as a stepped screw, wherein the diameter of the threaded pin 10 is smaller than the part of the bolt 9 which is arranged on the seat shell 3.

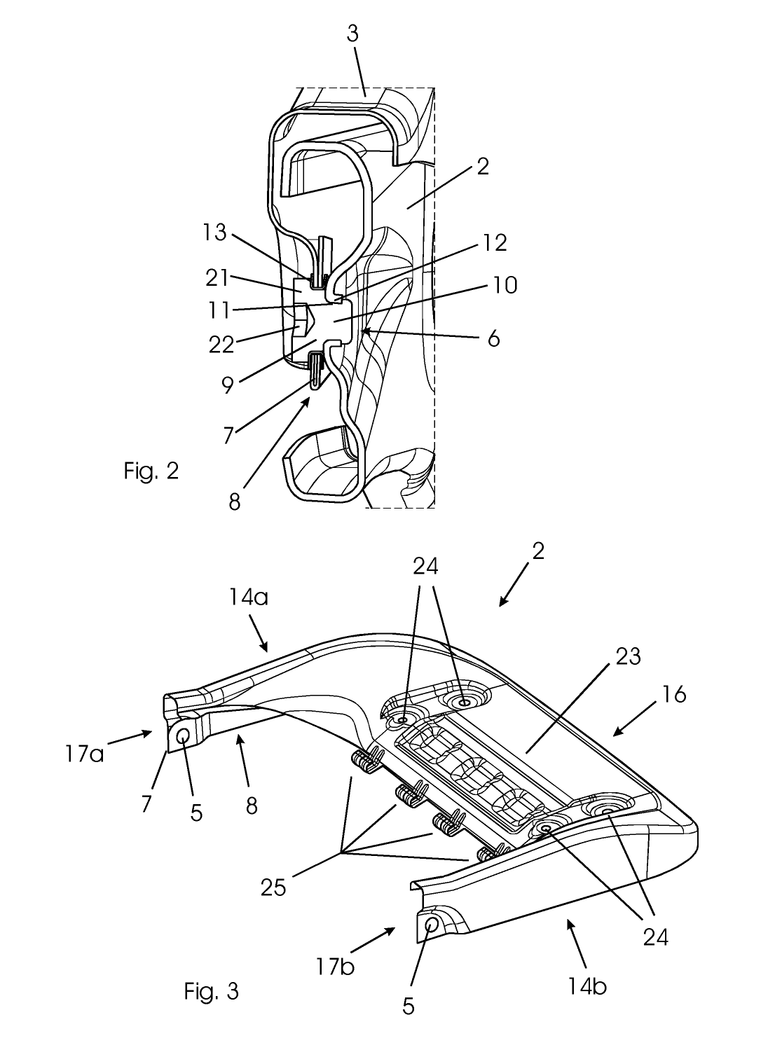

The bolt 9 in this case is guided in each case from the seat outer face through a bearing opening 5 of the seat shell 3, and fixedly screwed to the inner thread 12 of the receiver openings 4 of the seat frame 2 by an outer thread 11 of the threaded pin 10 (FIG. 2).

On the end face remote from the threaded pin 10, the bolt 9 has a cylindrical head 21, said bolt bearing with said head against the seat shell 3 in the region of the bearing opening 5 and/or against a bearing bush 13 arranged inside the bearing opening 5. Moreover, the bolt 9 in the region of the head 21 has a receiver for a hexagonal wrench 22 for screwing the threaded pin 10 of the bolt 9 into the receiver opening 4 of the seat frame 2.

As shown in FIG. 3, the seat shell 3 is formed as an integral component made of a metal sheet, wherein the metal sheet has a uniform material thickness in all regions of the seat shell 3.

The seat shell 3 comprises two side portions 15a, 15b for arranging on the seat frame 2 and a front portion 16 which connects the two side portions 15a, 15b and which, relative to the side portions 15a, 15b, has a recessed surface 23 and openings 24 and hooks 25 for fastening further components.

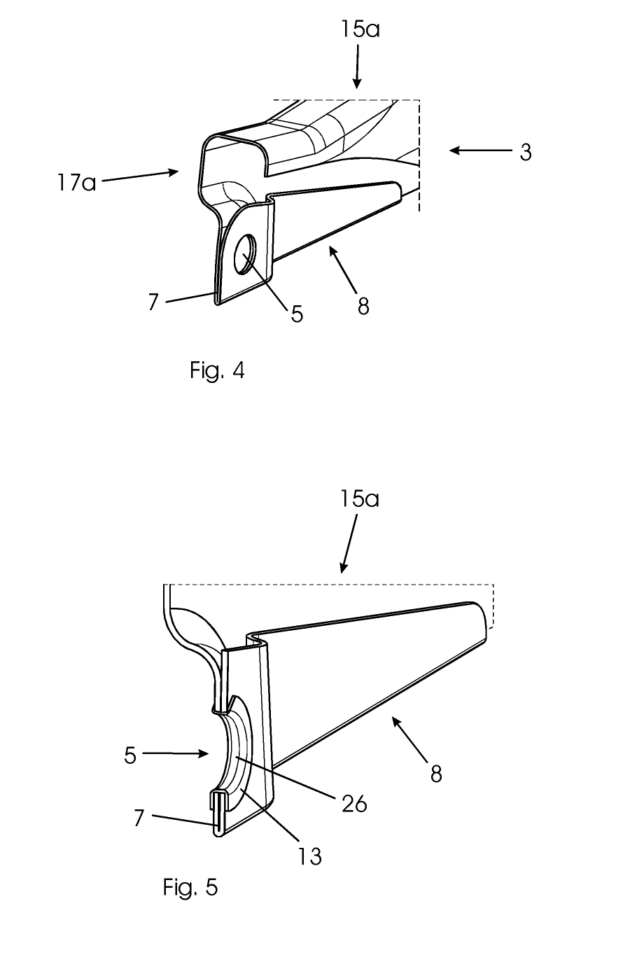

In the end regions 17a, 17b of the side portions 15a, 15b, in each case the bearing opening 5 is provided for receiving the bolt 9, wherein an edge region 8 of the seat shell 3 is bent back such that the metal sheet in the region of the bearing openings 5 and along a lower edge region 8 of the seat shell 3 is folded in two layers on top of one another (FIG. 4), whereby firstly the structure of the seat shell 3 is stabilized and at the same time the seat shell 3 is reinforced in the region of the bearing opening 5 and thus the material is effectively prevented from being sheared off when the inclination of the seat shell 3 is adjusted relative to the seat frame 2.

Moreover, a bearing bush 13 is arranged in the bearing opening 5, the outer regions of said bearing bush being bent back toward both sides of the bearing opening 5 onto the surface of the seat shell 3, whereby the bearing bush 13 additionally compresses the two sheet metal layers of the seat shell 3 located on top of one another in the region of the bearing opening 5, thus achieving a further reinforcement of this region, an elimination of rattling and improved bearing (FIG. 5). Moreover, the inner surface 26 of the bearing opening 5 is particularly smooth by the arrangement of the bearing bush 13 therein, whereby the seat shell 3 is advantageously mounted on the bolt 9 so as to slide in a particularly smooth manner.

While specific embodiments of the invention have been shown and described in detail to illustrate the application of the principles of the invention, it will be understood that the invention may be embodied otherwise without departing from such principles.

1. A device for adjusting a seat inclination of a motor vehicle seat, the device comprising:
a seat frame, and
a seat shell;
two fastening elements which each extend through a respective receiver opening on the seat frame and a respective bearing opening on the seat shell, to connect the seat frame to the seat shell in an articulated manner, wherein the material of the seat shell has a greater material thickness in a region of the bearing openings relative to the remaining regions of the seat shell.

2. The device as claimed in claim 1, wherein the seat shell, in the region of the bearing openings, has a material thickness which is at least twice as high relative to the remaining regions of the seat shell.

3. The device as claimed in claim 1, wherein the seat shell, in the region of the bearing opening, has a greater material thickness as a result of a folded-over portion of an edge region.

4. The device as claimed in claim 1, wherein each fastening element is formed by a bolt with a threaded pin, wherein an outer thread of the threaded pin cooperates with an inner thread formed on the receiver opening.

5. The device as claimed in claim 1, further comprising a bearing bush arranged on the bearing opening of the seat shell.

6. The device as claimed in claim 1, wherein the bearing bush secures two material layers of the seat shell positively and/or non-positively against one another, said material layers bearing against one another by means of a folded-over portion.

7. The device as claimed in claim 1, wherein the seat shell is formed in one piece and is comprised of a metal sheet.

8. The device as claimed in claim 1, wherein the seat shell has two side portions extending substantially parallel to two lateral regions of the seat frame and a front portion which is aligned with the seat front face and which connects together the two side portions of the seat shell.

9. The device as claimed in claim 1, wherein side portions of the seat shell extend over a part of a length of the seat frame, wherein the seat shell has approximately half the length of the seat frame.

10. The device as claimed in claim 1, wherein the bearing openings of the seat shell are respectively arranged in an end region of the side portions opposing the front portion.
